(19) United States
(12) Patent Application Publication
(10) Pub. No.: US 2009/0106067 A1
(43) Pub. Date: Apr. 23, 2009

(54) Schedule optimization system and method

(75) Inventors: Brian P. Mann, Sanger, TX (US); Harold W. Poage, Grand Prairie, TX (US)

Correspondence Address: Mr. Christopher John Rourk;Jackson Walker LLP, 901 Main Street, Suite 6000, DALLAS, TX, 75202, US

(73) Assignee: Rank One Sport

(21) Appl. No.: 11/975,756

(22) Filed: Oct. 22, 2007

(51) Int. Cl. G06Q 10/00; G06F 17/40; G06F 19/00

(52) U.S. Cl. 705/8

(57) ABSTRACT

A system for scheduling events is provided. The system includes a schedule system generating schedule data for an organization, such as a sports team associated with a school or university. Means for modifying the schedule data allows a user to identify a date, time, opposing team and location, such as based on the ratings percentage index for the opposing team. A notification system receives the modified schedule data and generates one or more messages based on the modified schedule data, such as a request to the opposing team to play a game with the sports team associated with the school or university at a selected time and location.

### FIELD OF THE INVENTION

The present invention relates to systems for scheduling events, and more particularly to an event scheduling system and method that identifies optimal events to be identified for scheduling based on user-identified selection criteria.

### BACKGROUND OF THE INVENTION

Scheduling software and systems are known in the art. Such software and systems allow parties to schedule events and invite participants, but do not assist parties with the identification of events that need to be scheduled. As such, while prior art systems and methods are useful once an event has been identified, they do not help a user to identify an event. When the event can be one of thousands of potential combinations, many of which may not be feasible due to variable constraints, a user must often rely on intuition to select events for scheduling due to the inability to determine which of each of the thousands of events is not only feasible but is also optimal based on user-specific selection criteria, resulting in lost opportunities to select optimal events for scheduling.

### SUMMARY OF THE INVENTION

Therefore, an event scheduling system and method are provided that allow users to identify and schedule events that are optimized based on user-entered selection criteria. In particular, an event scheduling system and method are provided that allow a user to quickly identify opposing teams for sporting events based on the potential benefit to the user's team from playing an opposing team, the location of the opposing team, available times and venues for events with the opposing team, and other user-selected criteria.

In accordance with an exemplary embodiment of the invention, a system for scheduling events is provided. The system includes a schedule system generating schedule data for an organization, such as a sports team associated with a school or university. Means for modifying the schedule data allows a user to identify a date, time, opposing team and location, such as based on the ratings percentage index for the opposing team. A notification system receives the modified schedule data and generates one or more messages based on the modified schedule data, such as a request to the opposing team to play a game with the sports team associated with the school or university at a selected time and location.

The present invention provides many important technical advantages. One important technical advantage of the present invention is a system and method for scheduling events that allows a user to determine which of a large number of potential events should be scheduled based on an optimal opposing team, an optimal location, an optimal time, or other user-selected variables.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a system for event scheduling in accordance with an exemplary embodiment of the present invention;

FIG. 2 is a diagram of a method for scheduling athletic events in accordance with an exemplary embodiment of the present invention; and

FIG. 3 is a diagram of a method for applying filters to event scheduling in accordance with an exemplary embodiment of the present invention.

### DETAILED DESCRIPTION OF PREFERRED EMBODIMENTS

In the description which follows, like parts are marked throughout the specification and drawing with the same reference numerals, respectively. The drawing figures may not be to scale and certain components may be shown in generalized or schematic form and identified by commercial designations in the interest of clarity and conciseness.

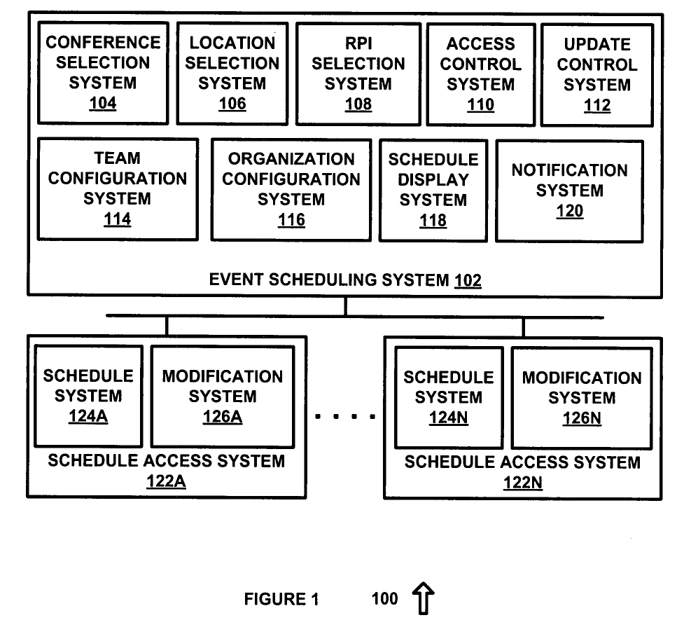

FIG. 1 is a diagram of a system 100 for event scheduling in accordance with an exemplary embodiment of the present invention. System 100 allows athletic administrators, coaches, or other personnel involved in sports programs to generate and modify a schedule for athletic events so as to optimize scheduling of events.

System 100 includes event scheduling system 102 which includes conference selection system 104, location selection system 106, RPI selection system 108, access control system 110, update control system 112, team configuration system 114, organization configuration system 116, schedule display system 118 and notification system 120, each of which can be implemented in hardware, software, or a suitable combination of hardware and software, and which can be one or more software systems operating on a general purpose processing platform. As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

Event scheduling system 102 allows events such as football games, baseball games, swimming events, team practices or other suitable athletic events to be scheduled. In one exemplary embodiment, event scheduling system 102 can be used by all schools in a division, a geographic region, a sports conference, or other suitable groups, so as to allow the athletic administrators, coaches, or other personnel associated with scheduling sporting events to have access to a centralized scheduling system and to facilitate the selection, scheduling and notification of events so as to avoid improperly scheduled events, team selection that is not optimal, events located at locations that require expensive travel, and other problems that are presently experienced in the scheduling of sporting events. In another exemplary embodiment, event scheduling system can be used to schedule practice times and locations, and to allow team players to obtain practice times and locations, receive notifications about rescheduled practice times or locations, or other suitable information.

Conference selection system 104 allows the user to select teams for events based on their conference, division, or other suitable categories. In one exemplary embodiment, conference selection system 104 can allow a user to select available teams for events based on a conference associated with the team, a division associated with the team, or other suitable data that can be used to classify the team based upon its suitability. In one exemplary embodiment, conference selection system 104 can also provide information such as whether an event with a team is a regularly scheduled event, a conference assigned event, or other suitable data.

Location selection system 106 allows location data for events to be provided, selected, or otherwise modified. In one exemplary embodiment, location selection system 106 allows the user to identify available venues for events, to impose constraints on events, such as a home team event, or to otherwise select or filter events based on location data.

RPI selection system 108 allows the user to view ratings percentage index (RPI) data for a selected team, such as the expected effect on a school's ratings percentage index based on the outcome of a game if it is scheduled against a selected team. Because the ratings percentage index is based on the opposing team's win/loss statistics as well as the win/loss statistics of the opposing team's opponents, calculation of the change in a selected team's ratings percentage index based on the outcome of a win or loss against an opposing team can be too complicated to perform manually, such that RPI selection system 108 can allow users to identify optimal opposing teams that would otherwise not be apparent. In one exemplary embodiment, RPI selection system 108 allows the user to determine whether and to what extent playing an opposing team would change a selected team's RPI if the opposing team were to win or lose a game against the selected team. In another exemplary embodiment, RPI selection system 108 can receive a plurality of opposing team identifiers and can generate a ranking showing the opposing teams that would have the greatest increase against the selected team's RPI. Likewise, additional data can be provided by RPI selection system 108, such as win/loss statistics for the current year for opposing teams or other suitable data. In one exemplary embodiment, RPI data and win/loss statistics can be updated during the playing season, such that a user can determine not only the effect on the selected team's RPI but also the odds that the selected team would have of a successful outcome against the opposing team. In another exemplary embodiment, RPI data can be based on a previous year's playing season, such that the RPI data for an opposing team might not be directly correlated to the odds of a successful outcome against the opposing team. In this embodiment, an opposing team that had a high RPI in a previous year but that has had a higher number of losses in the current year against weaker opponents might not be an optimal selection when compared with a different opposing team that had a lower RPI in a previous year but higher win/loss statistics for the current year against stronger opponents. RPI selection system 108 allows a user to view available RPI data, win/loss statistics for opposing teams and the teams that they have played, how many starting players for an opposing team returned or left, a team's conference record, whether or not a team was in the playoffs and how far they went, NCAA Division regional rankings, or other suitable data, so as to allow the user to identify optimal opposing teams for a selected team.

Access control system 110 controls access to event scheduling system 102. In one exemplary embodiment, access control system 110 can allow users who access event scheduling system 102 to have access to information regarding that user's conference, division, or other suitable filter data so as to prevent users from accessing schedule data for conferences, divisions or other organizations that they are not affiliated with. Likewise, access control system 110 can optimize the information provided to users so that the user only sees information that is pertinent to that user, such as the user's schedule and win/loss data, the user's available venues, opposing team's schedules, win/loss data and available venues, and other suitable data. Access control system 110 can also be used to limit access to events such as team practices, so as to restrict information for such events from being provided to persons that should not receive such information, such as coaches or players for opposing teams.

Update control system 112 controls access to event scheduling system 102 to allow updates. In one exemplary embodiment, update control system 112 can allow a user to update event times, schedule events, or otherwise modify data in event scheduling system 102 based upon a security level authorization or other suitable access controls. In another exemplary embodiment, update control system 112 can grant permission to predetermined users to update selected data for a team, event, or other suitable schedule data, such as to allow a coach to update schedule data for that coach's team, to allow a secretary or administrator to update schedule data for one or more selected teams, to allow a coach for an opposing team to update the selected team's schedule by accepting an event invitation, or in other suitable manners.

Team configuration system 114 receives team configuration data and filter settings and generates notification data for events related to a team. In one exemplary embodiment, team configuration system 114 can receive coach identification data, coach contact data, player identification data, player contact data, schedule data associated with a team, venue location data associated with a team, conference and division data for the team, or other team-related data. One or more filter settings can also be selected, such as to allow automatic acceptance for games based on user-selected criteria, to allow home games to be scheduled on predetermined dates, to allow games for requesting teams to be accepted on predetermined dates based on the location, ratings percentage index, a user-defined opposing team list, or other suitable data. Notification data can be generated to notify coaches, players, or other selected recipients to receive notification data for changes in events, schedules, alerts, or other suitable data. In another exemplary embodiment, team configuration system 114 can allow team members to provide availability data for practices or other events, so as facilitate scheduling of practices or events.

Organization configuration system 116 receives organization configuration data and filter settings and generates notification data for events related to an organization. In one exemplary embodiment, organization configuration system 116 can receive athletic coordinator identification data, team identification data, venue location data associated with an organization such as a franchise, school, or university, conference and division data for the organization, or other suitable organization-related data. Notification data can be generated to notify administrators, coaches, players, or other selected recipients to receive notification data for changes in schedules, alerts, or other suitable data.

Schedule display system 118 generates schedule data for an athletic organization, school, team, or other suitable entities. In one exemplary embodiment, schedule display system 118 allows a user to request and view schedule data for the user's athletic organization, another athletic organization, or other suitable schedules. In another exemplary embodiment, schedule display system 118 can provide schedule data for one or more events, a date, location, division, conference, or other suitable data, such as to allow a user to determine teams within a division that are available to play a game on a selected date, to view conference game schedules, to view practice schedules, or other suitable data.

Notification system 120 coordinates the generation and distribution of notification data from team configuration system 114, organization configuration system 116 or other suitable systems. In one exemplary embodiment, notification system 120 can generate emails, text messages, recorded telephonic messages, or other suitable data to provide notifications to selected persons utilizing predetermined communications channels. Notification system 120 can also track notification receipt, so as to generate alerts when notifications regarding event cancellations, rescheduled events, or other suitable notifications have not been acknowledged.

Schedule access systems 122a through 122n allow users to access event scheduling system 102, such as athletic directors, coaches, team members, or other individuals associated with an athletic program. In one exemplary embodiment, schedule access systems 122a through 122n can be enabled to allow access to event scheduling system 102 over the Internet, such as through a web browser, a thin client system, or other suitable systems.

Each of schedule access systems 122a through 122n includes schedule system 124a through 124n and modification system 126a through 126n, respectively. In one exemplary embodiment, schedule systems 124a through 124n and modification systems 126a through 126n can be implemented as HTML, active server pages or other suitable programs that are operated by a web browser with pre-determined functionality. Schedule systems 124a through 124n allow a user to access schedule information. In one exemplary embodiment, a school's athletic administer can access schedule data for all school sports, such as to determine when a facility such as a playing field will need to available, when travel to an opposing team's facility will be required, to reschedule practice locations or times, or other suitable data. In another exemplary embodiment, the coach or members for a team can access schedule information for that team's games, practice schedules, or other suitable access can be provided.

Modification systems 126a through 126n allow users to modify data in event scheduling system 102. In one exemplary embodiment, modification systems 126a through 126n can allow athletic directors to modify pre-determined data, such as school name data, contact information data, or other suitable data. Likewise, coaches can be provided authority to access game schedules to add games to a schedule, reschedule existing games, or to perform other suitable modifications. Likewise, modification systems 126a through 126n can allow an athletic director, coach or others to delegate modification authority to suitable persons, such as secretaries, assistant coaches, or other persons. Modification systems 126a through 126n can likewise be used to allow team members to update contact information, availability data for use in scheduling practices, or other suitable data.

In operation, system 100 allows personnel associated with athletic teams to access and modify schedule data. System 100 optimizes the scheduling of games and other athletic events so as to allow coaches or other personnel to determine available teams for rescheduled events, the optimal opposing teams for a selected team's RPI for discretionary events and other suitable parameters. System 100 thus provides functionality that is unavailable in prior art scheduling processes by allowing users to select optimal teams that are available for athletic events, to determine whether rescheduling the event can result in the availability of better teams, and to perform other suitable functions.

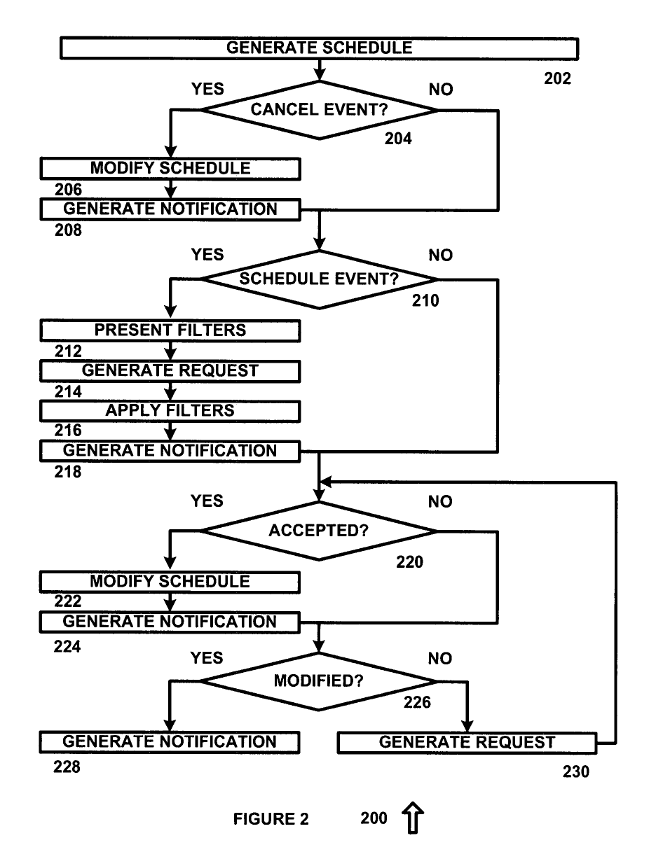

FIG. 2 is a diagram of a method 200 for scheduling athletic events in accordance with an exemplary embodiment of the present invention. Method 200 allows the user to generate or modify a schedule so as to optimize the opposing teams that events are scheduled with, the location of events, or to otherwise optimize scheduling of athletic events.

Method 200 begins at 202 where a schedule is generated. In one exemplary embodiment, the schedule can include existing schedule data, such as schedule data generated by a conference, division or other scheduling authorities. Likewise, where no schedule data has been entered, the schedule can be a blank schedule with associated data such as number of games to be played, mandatory opposing teams that need to be played, or other suitable information. The method then proceeds to 204.

At 204, it is determined whether an event should be cancelled. If it is determined that an event is not to be cancelled, the method proceeds to 210. Otherwise, the method proceeds to 206 where the schedule is modified. In one exemplary embodiment, the user can cancel a game, a practice or other events due to a conflict, weather, or suitable criteria. The method then proceeds to 208 where notifications are generated. In one exemplary embodiment, notification can be in the form of a text message, email message, or other suitable forms of communication when the cancelled game, practice or other event occurs at a pre-determined time in the future. Likewise, notification can include automated telephone calls to predetermined contact individuals so as to provide a quick alert where the cancelled event is occurring within a pre-determined period of time. An alert or other suitable notification data can also be generated to notify the user if a response to a notification has not been received, such as to allow the user to escalate notification or notify other persons. Other suitable notification procedures can also or alternatively be utilized. The method then proceeds to 210.

At 210, it is determined whether an event should be scheduled. In one exemplary embodiment, the system can analyze available teams and scheduled games or other events and determine if one or more of the available teams would provide a better match. In another exemplary embodiment, the system can receive a user selection to schedule a game, practice or other event, such as to replace a cancelled game or practice. If it is determined that no event is to be scheduled, the method proceeds to 220. Otherwise, the method proceeds to 212 where a plurality of filters are provided to the person scheduling the event. In one exemplary embodiment, the filters can allow a user to limit the available teams to those within a predetermined conference, division, geographic region or other suitable areas or divisions. Likewise, the filters can also allow a user to limit the teams to those within a predetermined distance to the users location, can allow a user to receive ratings percentage index data and win/loss data for an opposing team or the opponents of an opposing team, so as to optimize scheduling of the games, or can otherwise provide information to allow the user to optimize the scheduled game. Filters can also be used to determine practice times based on team member data that identifies when team members are available for a practice. The method then proceeds to 214.

At 214, a request is generated for a scheduled event. In one exemplary embodiment, team members or contact personnel for affected teams can receive a notification of the request. In this exemplary embodiment, the request can delay modification of a schedule until acceptance of the request. Likewise, where authorization has already been provided, such as when the entity performing the scheduling is a division director, conference director or other suitable persons, the request can also generate a schedule modification. In another exemplary embodiment, when team members have provided practice availability data, scheduling of a practice event can be performed without confirmation of a request, or a request can be generated for individual team members or other persons when an event would result in a conflict with those individuals. The method then proceeds to 216.

At 216, applicable filters are applied to requests. In one exemplary embodiment, the user can configure scheduling limitations so that requests for games that are outside of a predetermined area, on a blackout date, or based on other suitable filter criteria, have automatically generated responses. The responses can be acceptances, rejections, or other suitable automatic responses. Otherwise, the method proceeds to 218.

At 218, a notification is generated. In one exemplary embodiment, the notification can be an acceptance of a proposed event, a modification of a proposed event, or other suitable notifications. The method then proceeds to 220.

At 220, it is determined whether the scheduled event was accepted. If the scheduled event was not accepted or a request for acceptance was not provided, the method proceeds to 226. Otherwise, the method proceeds to 222 where the schedule is modified. In one exemplary embodiment, schedule modification can be performed after receipt of an acceptance, can be performed automatically based on a request where suitable filters have been provided to allow modification to be performed without receipt of notification and subsequent acceptance, or in other suitable manners. The method then proceeds to 224 where notifications of the schedule modifications are generated. In one exemplary embodiment, contact personnel associated with the teams having a modified schedule can receive a notification that the schedule has been modified. The method then proceeds to 226.

At 226, it is determined whether the request has been modified. In one exemplary embodiment, where a request has not been accepted but has been modified, such as to change a time, location, or other parameters, the method proceeds to 230 where a new request is generated. The request can include one or more notifications, such as a notification to the person that originally scheduled the event or other suitable notifications. The method then returns to 220. Otherwise, the method proceeds to 228, where a notification is generated, such as indicating that the requested scheduled event has been denied or rejected.

In operation, method 200 allows users to schedule events, such as to generate a schedule, to modify an existing schedule, to schedule discretionary events, or to otherwise optimize scheduling of events such as athletic games, team practices or other events.

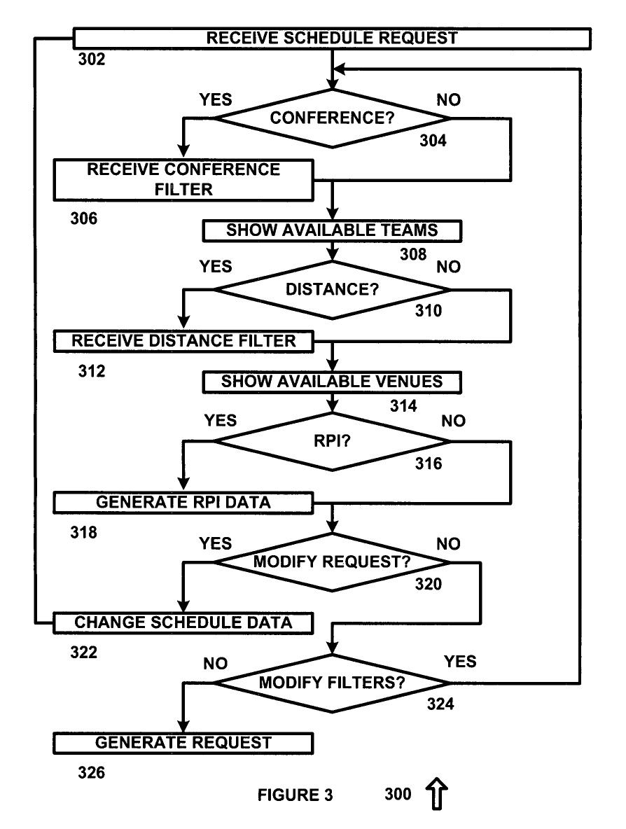

FIG. 3 is a diagram of a method 300 for applying filters to event scheduling in accordance with an exemplary embodiment of the present invention. Method 300 can be used to schedule events such as athletic games, team practices, to reschedule events, or in other suitable manners.

Method 300 begins at 302 where a scheduling request is received. Scheduling requests can include information such as a team identifier, conference, division, date, time, location or other suitable data. The method then proceeds to 304.

At 304, it is determined whether the event is a conference event, such as a conference game, a division game, or an event based on other suitable organizational categories. If it is determined that the event is not a conference event, the method proceeds to 308, otherwise it proceeds to 306 where a conference filter is received and applied to available teams. In one exemplary embodiment, where the scheduling request is to schedule a game for a particular conference, division, or other organization category, teams can be selected for consideration that are members of the conference, division or other category. Likewise, division filters, location filters or other suitable parameters can also be applied.

At 308, the set of available teams for a game are displayed. In one exemplary embodiment, a user can select one or more teams for subsequent consideration, can delete one or more teams from further consideration, or can otherwise modify the available teams. Likewise, where an event such as a practice for a team is being scheduled, 308 can be omitted. The method then proceeds to 310 where it is determined whether distance criteria are to be associated with the scheduling request. If it is determined that distance criteria are not to be applied, the methods proceeds 314, otherwise it proceeds to 312 where a distance filter is received and applied. In one exemplary embodiment, the distance filter can be a filter that restricts the list of teams based on a distance parameter, such as a maximum distance from a selected location, a location associated with the scheduler, whether the scheduling request is for a home game or away game or other suitable distance parameters. In another exemplary embodiment, the distance filter can be used to select practice venues based on a distance parameter such as the distance that team members can travel for a practice event. Such distance parameters can be entered by each team member, can be assigned based on a team policy for all team members, or other suitable processes can be used. The method then proceeds to 314.

At 314, available venues are displayed. In one exemplary embodiment, where more than one team is available to play, the venues associated with that team can also be displayed. Likewise, where a distance filter has been applied, available teams, practice locations, or other suitable data can be selected based on whether the team has a home game capability, whether a filter has been selected that limits the distance that a team, team members, or other persons will travel for an away game, a practice, or other suitable filters. In another exemplary embodiment, if a time and date have not been specified in the schedule request, available venues can be indicated with associated dates and time. In this exemplary embodiment, additional information can be provided by selecting a hypertext link associated with team or venue, can be provided as a pop-up menu when a user moves a cursor over a hypertext link for the selected team or venue, or in other suitable manners. The method then proceeds to 316.

At 316, it is determined whether ratings percentage index information is desired. If ratings percentage index information is not required, the method proceeds to 320. Otherwise, the method proceeds to 318 where a ratings percentage index score is generated based on a selected ratings percentage index parameter. In one exemplary embodiment, if the ratings percentage index for a plurality of the teams is desired, then the ratings percentage index for the teams can be sorted based in decreasing order or another suitable order. Likewise, additional information such as the current win/loss data for one or more teams, the ratings percentage index and win/loss data for the team's opponents, how many starting players for an opposing team returned or left, a team's conference record, whether or not a team was in the playoffs and how far they went, NCAA Division regional rankings, or other suitable information can be provided. Likewise, the RPI or other data for one or more years can also or alternatively be displayed, a user can generate a report or display for predetermined years, or other suitable processes can be used. In this exemplary embodiment, additional information can be provided with the ratings percentage index data, can be provided by selecting a hypertext link associated with team, can be provided as a pop-up menu when a user moves a cursor over a hypertext link for the selected team, or in other suitable manners. The method then proceeds to 320.

At 320, it is determined whether the request should be modified. In one exemplary embodiment, if the teams that are available based on a schedule request is unsatisfactory or if other parameters have changed based on the available teams, the method proceeds to 322 where the schedule data is changed. Likewise, if a team practice would result in an unacceptable number of team members being available, the method can proceed to 322. The method then returns to 302. Otherwise, the method proceeds to 324 where it is determined whether filters should be modified. In one exemplary embodiment, if the available teams, venues, RPI data or other scheduled request data have resulted in no available teams or other restrictions on teams, these filters can be modified to determine the effect on available teams. The method then returns to 304. Otherwise, the method proceeds to 326, where a request is generated for a selected event. In one exemplary embodiment, the request can include notifications to predetermined personnel such as coaches, athletic administrators, team members or other suitable personnel, and can also be implemented immediately depending upon the status data from those personnel or scheduled events can be delayed until acceptance of the proposed scheduling event.

In operation, method 300 allows the user to generate schedule requests for games, such as for season schedule generation, to reschedule a cancelled game, or for other purposes. Method 300 allows a user to restrict the number of available events based on user-selected criteria, so as to allow the user to readily select optimal events from a large number of potential events based on criteria that are of interest to the user. For example, if a user has a limited travel budget, teams that are available to play a home game at the user's facility or that are located within a predetermined distance can be selected. Likewise, if a user has no travel restrictions and is interested in optimizing events based on the ratings percentage index associated with opposing teams, the user can locate optimal teams and determine when and where such teams are available for an event. Other suitable combinations of user-selected criteria can also or alternatively be used to allow a user to select and schedule events that are optimized based on user-specific selection criteria.

In view of the above detailed description of the present invention and associated drawings, other modifications and variations are apparent to those skilled in the art. It is also apparent that such other modifications and variations may be effected without departing from the spirit and scope of the present invention.

What is claimed is:

1. A system for scheduling events comprising:
a schedule system generating schedule data for an organization;
means for modifying the schedule data; and
a notification system receiving the modified schedule data and generating one or more messages based on the modified schedule data.

2. The system of claim 1 wherein the means for modifying the schedule data comprises means for identifying one or more teams for an event.

3. The system of claim 1 wherein the means for modifying the schedule data comprises means for identifying one or more teams associated with a conference for an event.

4. The system of claim 1 wherein the means for modifying the schedule data comprises means for identifying one or more teams for an event based on ratings percentage index data.

5. The system of claim 1 further comprising a team configuration system receiving team data and providing the team data to the notification system.

6. The system of claim 1 further comprising an organization configuration system receiving organization data and providing the organization data to the notification system.

7. A method for scheduling events comprising:
generating schedule data for an organization;
receiving a request to modify the schedule data;
applying one or more filters to data for a plurality of other organizations;
receiving a selection of one or more of the other organizations after application of the one or more filters; and
generating schedule modification data.

8. The method of claim 7 wherein applying the one or more filters to the data for the plurality of other organizations comprises applying a conference filter to identify the other organizations that are associated with a conference.

9. The method of claim 7 wherein applying the one or more filters to the data for the plurality of other organizations comprises applying a location filter to identify the other organizations that are associated with a location parameter.

10. The method of claim 7 wherein applying the one or more filters to the data for the plurality of other organizations comprises applying a ratings percentage index filter to identify the other organizations that are associated with a ratings percentage index parameter.

11. The method of claim 7 further comprising:
generating notification data based on the schedule modification data;
generating modified schedule modification data based on the notification data; and
generating response notification data based on the modified schedule modification data.

12. A system for selecting teams for sporting events comprising:
a conference selection system receiving division data and generating a set of teams associated with the division data;
an event scheduling system receiving the set of teams associated with the division data and event date data and generating a set of teams associated with the event date data; and
means for selecting one of the set of teams associated with the event date data.

13. The system of claim 12 further comprising a location selection system receiving a location parameter, the set of teams associated with the division data and the event date data and generating a set of teams associated with the location parameter.

14. The system of claim 12 further comprising a ratings percentage index system receiving a ratings percentage index parameter, the set of teams associated with the division data and the event date data and generating a set of teams associated with the ratings percentage index parameter.

15. The system of claim 12 further comprising:
a team configuration system receiving the selected team associated with the event date data and generating notification roster data; and
a notification system receiving the notification roster data and generating one or more notification messages.

16. A method for scheduling events comprising:
requesting schedule data for an organization;
transmitting a request to modify the schedule data;
selecting one or more filters to filter data for a plurality of other organizations;
receiving a selection of one or more of the other organizations after application of the one or more filters; and
transmitting a request to schedule an event with one of the one or more of the other organizations.

17. The method of claim 16 wherein selecting the one or more filters to filter the data for the plurality of other organizations comprises selecting a division filter to identify one or more of the plurality of other organizations that are associated with a division parameter.

18. The method of claim 16 wherein selecting the one or more filters to filter the data for the plurality of other organizations comprises selecting a location filter to identify one or more of the plurality of other organizations that are associated with a location parameter.

19. The method of claim 16 wherein selecting the one or more filters to filter the data for the plurality of other organizations comprises:
selecting a ratings percentage index filter; and
receiving ratings percentage index data for one or more of the plurality of other organizations.

20. A system for filtering organization data comprising:
a ratings percentage index system storing ratings percentage index data for a plurality of teams;
a schedule display system generating a schedule for one of the plurality of teams; and
means for selecting another of the plurality of teams based on the ratings percentage index data for the plurality of teams.

21. The system of claim 20 further comprising means for selecting another of the plurality of teams based on location data for the plurality of teams.

22. The system of claim 20 further comprising means for selecting another of the plurality of teams based on division data for the plurality of teams.

23. The system of claim 20 further comprising means for generating a schedule modification request to modify the schedule for the one of the plurality of teams.
